(19) United States
(12) Patent Application Publication
(10) Pub. No.: US 2014/0366812 A1
(43) Pub. Date: Dec. 18, 2014

(54) ANIMAL PROTECTIVE DEVICE AND METHODS OF MAKING AND USING SAME

(71) Applicant: Stephanie Leone, San Diego, CA (US)

(72) Inventor: Stephanie Leone, San Diego, CA (US)

(21) Appl. No.: 14/304,627

(22) Filed: Jun. 13, 2014

Related U.S. Application Data
(60) Provisional application No. 61/835,440, filed on Jun. 14, 2013.

(51) Int. Cl. A01K 1/06

(52) U.S. Cl. CPC A01K 1/0613
USPC 119/712; 29/428

(57) ABSTRACT

An animal protective device and methods of making and using it are disclosed for restraining and injecting an animal. The device includes a semi-rigid rectangular panel including a handle and a plurality of holes that are substantially centered on the panel. The device further includes a skirt attached to the rear of the panel and disposed around its circumference. In an embodiment, the holes are configured such that approximately half of the holes are arranged in a semi-circular arc on one side of the handle and the remaining holes are arranged in a semi-circular arc on the opposite side of the handle.

### RELATED APPLICATION

This application claims priority to U.S. provisional patent application, entitled ANIMAL PROTECTIVE DEVICE AND METHODS OF MAKING AND USING SAME, Application No. 61/835,440, filed Jun. 14, 2013 and incorporates it in its entirety.

### FIELD OF THE INVENTION

The present invention in general relates to animal protective devices and methods of making and using them.

### BACKGROUND OF THE INVENTION

There is no admission that the background art disclosed in this section legally constitutes prior art.

There have been many different types of animal restraining and protection devices for use by handlers such as veterinary or animal shelter personnel when attempting to restrain and sedate an animal. Often such animals are under duress from being in an unfamiliar environment or around unfamiliar people, or from being sick, making it necessary to sedate the animal for treatment. Accordingly, there have been attempts to provide a device that allows a handler to inject a sedative with a syringe needle into the animal that also provides safety for both the handler and the animal.

Conventional restraining systems are often tube-shaped and are typically made for use with small rodents in the animal research field where the handler must first place the rodent into the tube before administering a sedative. See for example, U.S. Pat. Nos. 5,816,197, 5,927,234 and 7,874,270.

Other conventional restraining systems are conical or planar in shape, but either require a handler to get an animal to go into the conical shaped device, or are designed to only cover an animal's forepaws without restricting other movement by the animal. See for example, US patent application publication 2011/0308478.

Another conventional shield relates to an umbrella-shaped device designed for a specific purpose of defending a postman against attacking dogs. See, European patent application 87304007.5.

Recently, attempts have been made to make protective shields for animal handlers that are planar in shape to control and sedate a small animal. See for example, “The Scratch Shield” and the “ACES Cat/Small Animal Shield.” In both of these proposals, the shields comprise a clear plastic material and include a handle and a plurality of holes in the shield. Such devices allow a handler to attempt to immobilize an animal against the back of a cage in order to inject them.

However, because the plastic shields are clear, the animal can see a handler approaching which can increase the animal's stress level. In addition, both of these proposed devices comprise a plurality of holes that substantially encompass the entire surface of the shield. Therefore, a handler would be required to use additional judgment and time to determine which hole to administer an injection. Further, in the “ACES Cat” proposal, the holes appear large enough so that an animal such as a cat would be able to easily reach a paw through it to scratch or even bite a handler. Moreover, because both of these shields are designed to push an animal back into a cage, an animal can potentially struggle around the sides of the shields, with the only exception being a situation where the shield has the same dimensions as the cage.

Thus, it would be highly desirable to have an animal protective device that can allow a handler to effectively restrain a fractious animal to inject a sedative while protecting both the handler and the animal.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1 is a front plan view of an animal protective device, which is constructed in accordance with an embodiment;

FIG. 2 is a rear perspective view of the animal protective device of FIG. 1;

FIG. 3 is a front perspective view of the animal protective device of FIG. 1 illustrating use with an animal in a cage; and

FIG. 4 is a partial front perspective view of the animal protective device of FIG. 3 illustrating use with an animal in a cage.

### DETAILED DESCRIPTION OF CERTAIN EMBODIMENTS OF THE INVENTION

Certain embodiments of the present invention will now be described more fully hereinafter with reference to the accompanying drawings, in which some, but not all, embodiments of the invention are shown. Indeed, these embodiments of the invention may be in many different forms and thus the invention should not be construed as limited to the embodiments set forth herein; rather, these embodiments are provided as illustrative examples only so that this disclosure will satisfy applicable legal requirements. Like numbers refer to like elements throughout.

It will be readily understood that the components of the embodiments as generally described and illustrated in the drawings herein, could be arranged and designed in a wide variety of different configurations. Thus, the following more detailed description of the certain ones of the embodiments of the system, components and method of the present invention, as represented in the drawings, is not intended to limit the scope of the invention, as claimed, but is merely representative of the embodiment of the invention.

An animal protective device and methods of making and using it are shown and described herein. The device may include a semi-rigid rectangular panel including a handle and a plurality of holes substantially centered on the panel. In an embodiment, the device may further include a skirt attached to the rear of the panel and disposed around its circumference. The holes may be configured such that approximately half of the holes are arranged in a semi-circular arc on one side of the handle and the remaining holes are arranged in a semi-circular arc on the opposite side of the handle. In an embodiment, the plurality holes may comprise approximately ten holes such that approximately five holes are configured in a semi-circular arc shape and located on one side of the handle and the remaining of the plurality of holes are configured in a semi-circular arc shape and located on the opposite side of the handle. In an embodiment, each of the plurality holes are approximately the size of U.S. quarter coin.

The method of making the animal protective device may include attaching a handle to the front of a rectangular panel having a plurality of holes. A skirt may be attached to the rear of the panel and disposed around its circumference. The holes may be created and configured such that approximately half of the holes are arranged in a semi-circular arc on each side of the handle. In an embodiment, the plurality holes may comprise approximately ten holes such that approximately five holes are configured in a semi-circular arc shape and located on one side of the handle and the remaining of the plurality of holes are configured in a semi-circular arc shape and located on the opposite side of the handle. In an embodiment, each of the plurality holes are approximately the size of U.S. quarter coin.

The method of using the animal protective device may include holding a handle attached to a panel having a plurality of holes, pushing the panel towards an animal to restrain the animal and injecting a hypodermic needle into the animal's flesh through one of the holes. In an embodiment, the holes may be configured such that approximately half of the holes are arranged in a semi-circular arc on one side of the handle and the remaining holes are arraigned in a semi-circular arc on the opposite side of the handle, therefore allowing a handler to selectively inject a sedative or other substance into a fleshy, muscular portion of the animal's body.

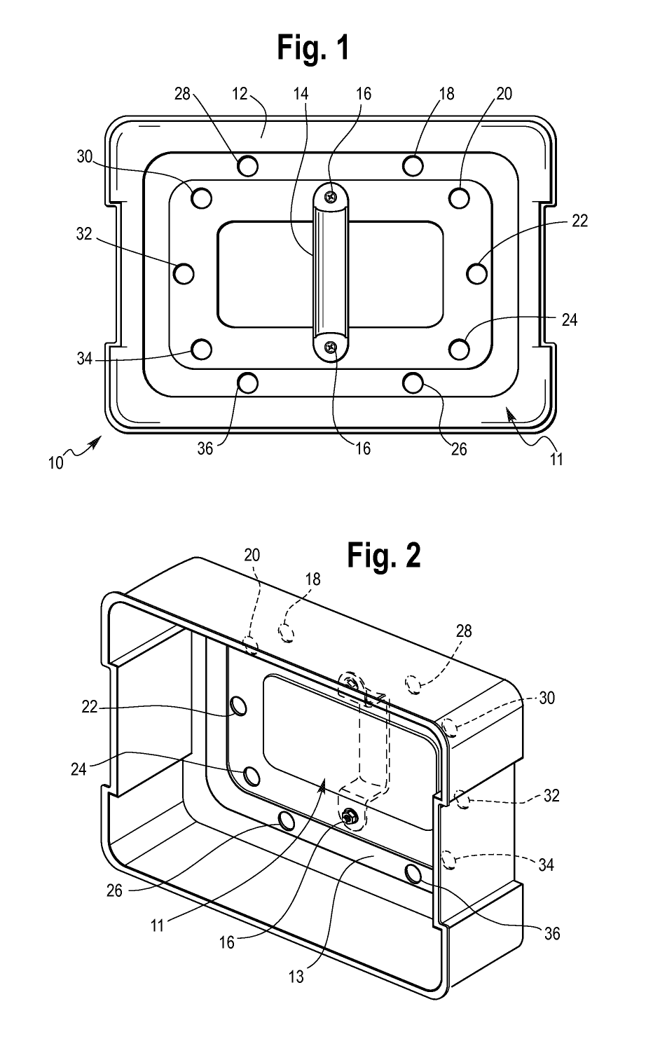

Referring now to the drawings, and more particularly to FIGS. 1 and 2, there is shown an animal protective device 10 which may be constructed in accordance with an embodiment. As illustrated in FIGS. 1 and 2, the device 10 includes a generally rectangular panel 11. The panel 11 may comprise other shapes such as being general oblong or hemispherical. In an embodiment, the panel 11 comprises a suitable semi-rigid material such as molded plastic that is relatively lightweight and provides good durability. In other embodiments, the panel 11 may comprise more rigid materials such as metal or glass. In addition, the panel 11 may comprise a material that is substantially opaque in order to provide visual cover for a handler while approaching an animal, which can help decrease the stress level of the animal.

The panel 11 may include a handle 14 disposed on a front side 12 of the panel 11. The handle 14 is generally centered on the panel 11 and may comprise a rigid material such as metal or plastic. In an embodiment, the handle 14 is attached to the panel 11 with fasteners 16 located on the top and bottom of the handle 14 and are disposed through the panel 11. The handle 14 allows a handler to control the animal protective device 10 during use. In another embodiment, the handle 14 may comprise an integrated portion of the panel 11 without the need for any additional fasteners.

The panel 11 may include a plurality of holes 18, 20, 22, 24, 26, 28, 30, 32, 34 and 36 located around the handle 14. In an embodiment, the plurality of holes 18, 20, 22, 24, 26, 28, 30, 32, 34 and 36 are arranged such that half are disposed on the left side of the handle 14 and the other half are disposed on the right side of the handle 14. In particular, the holes 18, 20, 22, 24 and 26 are located on the left side of the handle 14 and holes 28, 30, 32, 34 and 36 are located on the right side of the handle 14. In an embodiment, the two halves of holes 18, 20, 22, 24 and 26, and holes 28, 30, 32, 34 and 36 are each arranged to form a semi-circular arc on opposite sides of the handle 14. In other embodiments, the plurality of holes 18, 20, 22, 24, 26, 28, 30, 32, 34 and 36 may comprise other arrangements such as generally linear or box-shaped in order to provide access for the handler to the animal's flesh.

The size or sizes of the holes 18, 20, 22, 24, 26, 28, 30, 32, 34 and 36 are designed such that the holes are large enough to allow a handler to insert a finger if necessary and to deliver an injection through the hole. However, the holes 18, 20, 22, 24, 26, 28, 30, 32, 34 and 36 must not be so large as to allow an animal to reach a claw through the hole to scratch or even bite the handler. In one embodiment, the holes are approximately the size of a U.S. quarter coin, but other sizes are possible depending upon the size of the animal for which the device 10 is used.

The two sets of holes 18, 20, 22, 24 and 26 and holes 28, 30, 32, 34 and 36 are located around the handle 14 such that when a handler restrains an animal with the animal protective device 10, the handler can administer an injection into the animal through any one of the plurality of holes 18, 20, 22, 24, 26, 28, 30, 32, 34 and 36 into a central portion of the body of the animal. Having only a limited number of holes 18, 20, 22, 24, 26, 28, 30, 32, 34 and 36 allows a handler to make a quick and accurate determination of which hole to administer a safe injection.

As illustrated in FIG. 2, the animal protective device 10 further comprises a skirt 15 attached to the back side 13 of panel 11. The skirt 15 is disposed around the circumference of the back side 13 of the panel 11 so that the panel 11 and the skirt 15 form a hollow, cup-shaped enclosure. The depth of the skirt 15 is deep enough to prevent an animal from slipping around the edge of the panel 11, yet is not so deep that the animal can move away from the plurality of holes 18, 20, 22, 24, 26, 28, 30, 32, 34 and 36 in order to avoid an injection. Like the panel 11, the skirt 15 may comprise an opaque, semi-rigid material such as molded plastic that is durable, lightweight and provides visual cover for the handler.

In an embodiment, the animal protective device 10 is appropriately sized to restrain an animal such as an average cat that weighs approximately 12-23 pounds. Accordingly, the length and width of the panel 11 and the depth of the skirt 15 are designed to be large enough to restrain a cat but small enough to not allow excessive movement. In other embodiments, the dimensions of the animal protective device 10 can be modified to accommodate different sized animals. For example, a handler might have a need for three sizes of the animal protective device 10 (small, medium and large) for three different sizes of animals.

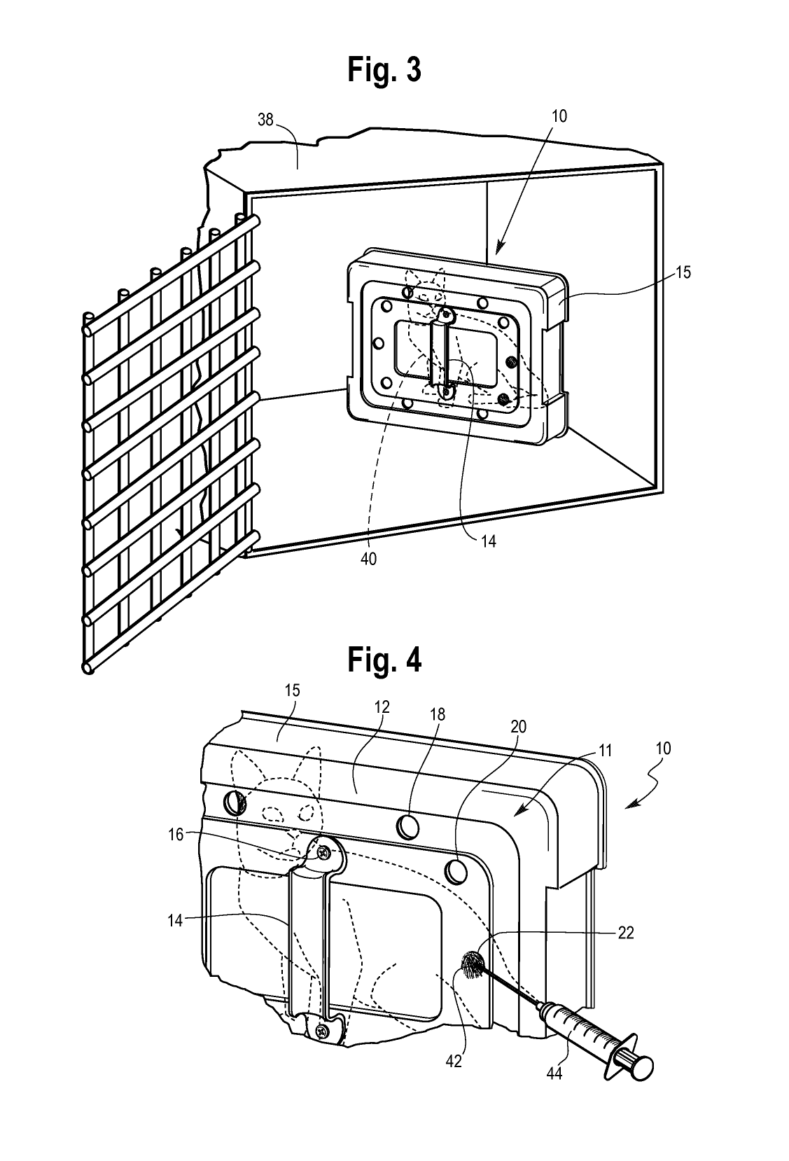

Referring now to FIGS. 3 and 4, there is shown an animal protective device 10 in use in accordance with an embodiment. As illustrated in FIGS. 3 and 4, an animal, such as a fractious cat 40, is located within a cage 38. When using an animal protective device 10, a handler picks up the device 10 by grasping the handle 14. When the handler desires to sedate the cat 40, the handler moves the animal protective device 10 towards the cat 40. Because the device 10 comprises a substantially opaque material, the cat's view of the handler is shielded by the device 10, thus allowing for a more stealthy approach by the handler. In addition, because the device 10 is lightweight, the handler can maneuver the animal protective device 10 with one hand, which allows the handler to use their other hand to hold a syringe 44 and inject the cat 40.

As the handler approaches the fractious cat 40, the handler pushes the animal protective device 10 up against the cat 40 and into a corner or side of the cage 38. Because the device 10 is designed to be a size that is slightly larger than the cat 40, the hollow, cup-shaped enclosure formed by the back side 13 of the panel 11 and the skirt 15 effectively encloses and restrains the cat 40 against the cage 38. Further, the panel 11 and the skirt 15 protect the handler from scratches or bites from the cat 40.

Once the handler restrains the cat 40 with the animal protective device 10, a portion of the flesh of the cat 40 can protrude through one or more of the plurality of holes 18, 20, 22, 24, 26, 28, 30, 32, 34 and 36. As illustrated in FIG. 4, a portion of the flesh 42 of the cat 40 is protruding out of hole 22. Because the two sets of holes 18, 20, 22 and 24 and holes 26, 28, 30, 32 and 34 are located around the handle 14, all of the holes, including hole 22, may cover a central portion of the body of the cat 40. Accordingly, the handler can then use the syringe 44 to safely administer an injection or provide other treatment through hole 22 into a fleshy, muscular portion of the restrained cat 40.

In other embodiments, the animal protective device 10 can be used to restrain an animal that in not located in a cage. For example, the animal protective device 10 can be used to restrain and inject an animal against a wall, in a corner, in a vehicle or in an animal carrying case.

Although the invention has been described with reference to the above examples, it will be understood that many modifications and variations are contemplated within the true spirit and scope of the embodiments of the invention as disclosed herein. Many modifications and other embodiments of the invention set forth herein will come to mind to one skilled in the art to which the invention pertains having the benefit of the teachings presented in the foregoing descriptions and the associated drawings. Therefore, it is to be understood is that the invention shall not be limited to the specific embodiments disclosed and that modifications and other embodiments are intended and contemplated to be included within the scope of the appended claims. Although specific terms are employed herein, they are used in a generic and descriptive sense only and not for purposes of limitation.

What is claimed is:

1. An animal protective device, comprising:
a panel including a plurality of holes; and
a handle attached to the panel.

2. The animal protective device of claim 1, wherein the device further comprises a skirt attached to the panel.

3. The animal protective device of claim 1, wherein the panel is substantially rectangular in shape.

4. The animal protective device of claim 1, wherein the plurality of holes are configured such that approximately half of the plurality of holes are configured in a semi-circular arc shape and located on one side of the handle and the remaining of the plurality of holes are configured in a semi-circular arc shape and located on the opposite side of the handle.

5. The animal protective device of claim 4, wherein the plurality of holes comprises approximately ten holes, and wherein approximately five holes are configured in a semi-circular arc shape and located on one side of the handle and the remaining of the plurality of holes are configured in a semi-circular arc shape and located on the opposite side of the handle.

6. The animal protective device of claim 1, wherein each of the plurality of holes are approximately the size of U.S. quarter coin.

7. A method of making an animal protective device, comprising:
providing a panel including a plurality of holes; and
attaching a handle to the panel.

8. The method of claim 7, wherein the method further comprises attaching a skirt to the panel.

9. The method of claim 7, wherein the panel is substantially rectangular in shape.

10. The method of claim 7, wherein the method further comprises configuring the plurality of holes such that approximately half of the plurality of holes are configured in a semi-circular arc shape and located on one side of the handle and the remaining of the plurality of holes are configured in a semi-circular arc shape and located on the opposite side of the handle.

11. The method of claim 10, wherein the plurality of holes comprises approximately ten holes, and wherein approximately five holes are configured in a semi-circular arc shape and located on one side of the handle and the remaining of the plurality of holes are configured in a semi-circular arc shape and located on the opposite side of the handle.

12. The method of claim 7, wherein each of the plurality of holes are approximately the size of U.S. quarter coin.

13. A method of using an animal protective device to restrain and inject an animal, comprising:
pushing a panel including a handle and a plurality of holes towards an animal; and
injecting the animal through one of the plurality of holes.
